(19) United States
(12) Patent Application Publication
(10) Pub. No.: US 2026/0371432 A1
(43) Pub. Date: Nov. 19, 2026

(54) CONTEXT SENSITIVE LEASHING FOR ACCESSORY DEVICES

(71) Applicant: Apple Inc., Cupertino, CA (US)

(72) Inventors: Benjamin A. Werner, San Jose, CA (US); Tunc Ertan, Santa Clara, CA (US); Michele Bavaro, Cupertino, CA (US); Pranati Kuppa, Irvine, CA (US); Anup Dhital, San Jose, CA (US); Benjamin A. Detwiler, San Diego, CA (US); Brent M. Ledvina, San Francisco, CA (US); Todd Wheeler, San Jose, CA (US)

(73) Assignee: Apple Inc., Cupertino, CA (US)

(21) Appl. No.: 19/664,805

(22) Filed: Apr. 30, 2026

Related U.S. Application Data
(60) Provisional application No. 63/808,485, filed on May 19, 2025.

(51) Int. Cl. H04W 76/19; H04W 64/00; H04W 76/30

(52) U.S. Cl. CPC H04W 76/19; H04W 64/00; H04W 76/30

(57) ABSTRACT

Techniques are disclosed for managing network connections between a user device and an accessory device. A user device can determine a dwell time at a location. The user device can determine whether the dwell time exceeds a threshold time. The user device can then terminate a network connection with an accessory device. The accessory device can be present at the location with the user device.

### CROSS-REFERENCE TO RELATED APPLICATION

This application claims the benefit of U.S. Provisional Application No. 63/808,485, entitled “CONTEXT SENSITIVE LEASHING FOR ACCESSORY DEVICES,” filed May 19, 2025, the disclosure of which is incorporated by reference herein in its entirety.

### BACKGROUND

Many accessory devices like headphones, styluses, and electronic finders can communicate with electronic user devices via Bluetooth or other wireless connections. In some cases, these accessory devices may not include components like global positioning system (GPS) receivers for determining the location of the accessory devices. Instead, locating components of the electronic user devices can be used to determine the locations of the accessory devices with which they communicate.

### BRIEF DESCRIPTION OF THE DRAWINGS

FIG. 1 illustrates a block diagram and a flowchart showing an example process for terminating a network connection between a user device and an accessory device, according to some embodiments.

FIG. 2 illustrates a diagram including a user device leashed to various accessory devices, according to some embodiments.

FIG. 3 illustrates a diagram of different leashing states of a user device and an accessory device at different locations, according to some embodiments.

FIG. 4 illustrates a table of leashing policies that may be implemented by a user device, according to some embodiments.

FIG. 5 illustrates an example architecture or environment configured to implement techniques described herein, according to some embodiments.

FIG. 6 illustrates a flowchart showing an example process for terminating a network connection, according to some embodiments.

FIGS. 7A and 7B illustrate methods of application processes, in accordance with some embodiments.

FIG. 7C illustrates a device for implementing an API, in accordance with some embodiments.

FIG. 7D illustrates a system for implementing an API, in accordance with some embodiments.

FIGS. 7E and 7F illustrate data flows related to API processes, in accordance with some embodiments.

### DETAILED DESCRIPTION OF THE INVENTION

The examples described herein relate to techniques, electronic user devices, systems, computer-readable media, and the like for managing, terminating, and re-acquiring a persistent network connection between an electronic user device like a smartphone and an accessory device like a Bluetooth beacon or other electronic finder. Many accessory devices are equipped with communication components like Bluetooth Low Energy transceivers that allow for wireless connections with electronic user devices. These accessory devices may not have their own locating components like GPS and may therefore be unable to determine their own location. An electronic user device like a smartphone often does have components and related software to determine the location of the electronic user device. The electronic user device can therefore use its location to determine the location of an accessory device connected to the electronic user device.

For example, a smartphone can connect to and communicate with an electronic finder device like a finder tag using a Bluetooth connection. The smartphone can include a locating application that executes on the smartphone (e.g., as a background process) that can determine the location of the smartphone. The smartphone can also determine location of the finder tag relative to the smartphone by using the Bluetooth connection or other wireless connection (e.g., ultrawideband radio). The smartphone can then associate the smartphone location and the relative location of the finder tag to update a location for the finder tag, for example by updating data stored on the smartphone for the location of the finder tag or uploading location information for the finder tag to a server device. In some cases, the smartphone can determine the location of the finder tag in response to receiving a communication from the finder tag. In other cases, the smartphone can transmit a communication to the finder tag and receive a response from the finder tag, after which the smartphone can determine the location of the finder tag.

Accessory devices like finder tags and ear bud headphones (and their cases) may be carried by a user along with an electronic user device like a smartphone or tablet device. In the event that the accessory device is inadvertently left behind at a location by the user, the electronic user device may be configured to establish and maintain a persistent network connection with the accessory device. This persistent network connection may be referred to herein as a “leash.” For example, an electronic user device can be leashed to an accessory device with a persistent Bluetooth connection in which the electronic user device transmits a signal (or other data) to the accessory device at an interval and receives a corresponding signal in response. The electronic user device can maintain a record of its location, which can be determined by the location application or process executing on the electronic user device. If the accessory device is left behind, the electronic user device can identify that the accessory device is no longer in range to maintain the network connection. The electronic user device can then use the most recent location of the electronic user device at the time the network connection was lost to determine a last known location of the accessory device. The electronic user device can also take additional actions like alerting the user of the “left behind” accessory device. A leash may be established between an accessory device and an electronic user device associated with a user account of an “owner” of the accessory device. For example, a user can add an accessory device to an account that is accessible on a smartphone. Then, when that particular accessory device is in proximity to the smartphone, the accessory device can be leashed to that particular smartphone.

As noted above, accessory devices can also be configured to broadcast (“advertise”) to nearby devices for the purposes of locating the accessory devices via a distributed mechanism. For example, a finder tag can broadcast data via Bluetooth that can be received by appropriately configured user devices nearby, which can then determine a location of the finder tag and anonymously provide that location information to a server device that can later be accessed by an owner of the finder tag. When the accessory device is leashed to an electronic user device (e.g., in proximity to the owner's smartphone), the accessory device may be configured to not also broadcast for the purposes of the distributed locating mechanism.

Some accessory devices may be configured to continue broadcasting even while leashed to an electronic user device. For example, an owner of the accessory device may want the accessory device to be locatable using another electronic user device associated with the owner's account like a tablet device. In these cases, the accessory device may be leashed to the owner's smartphone while the accessory device is with the owner, but can also broadcast data that is useable to determine its location so that the associated tablet device can also receive location information for the accessory device. In some examples, the broadcast data can also be used to connect the accessory device with the other electronic user device to perform actions with respect to the accessory device including, for example, playing a sound at the accessory device or performing ranging or locating operations for the accessory device.

Maintaining the leash while the accessory device also broadcasts can consume significant power. To avoid the increased power consumption, the electronic user device can terminate and reestablish the leash with an accessory device according to whether the electronic user device and the accessory device are determined to be “dwelling” at a location. If the electronic user device and the accessory device are detected as being at a particular location for more than a threshold time (e.g., the owner of the devices is staying in the same location), then the leash can be terminated to save power for the accessory device. Once the electronic user device detects that it has left the location (e.g., the owner is traveling), the electronic user device can reestablish the leash to resume the accurate accessory device locating feature that the leash provides.

The techniques described herein provide several advantages over conventional accessory device network connection management. As noted above, significant power savings can be achieved by dropping a leash to an accessory device at locations where the accessory device's location is not changing frequently. For example, an accessory device that is leashed to an electronic user device and also broadcasting may consume about 40 μW of power, while the accessory device may consume about 20 μW of power when only broadcasting. Since accessory devices may run on batteries that are intended to be replaced infrequently, managing the leash with the accessory device can consume less power and provide substantially longer battery life for these accessory devices. Moreover, advancements in locating technology using ultrawideband radios on accessory devices can consume additional power, so that improvements in power consumption due to leash management can allow the advanced locating mechanisms to function without further modifications to the power supply (e.g., larger, more cumbersome batteries). Additionally, the leash can be reestablished between the electronic user device and the accessory devices upon detecting that both devices are moving, so that the improved locating functionality of the leash is present when the location of the accessory device is changing frequently.

As a further advantage, an electronic user device that selectively drops a leash with one or more accessory devices may conserve bandwidth resources. For example, the leash can require a communication and data exchange with the accessory device at an interval (e.g., every 1 s). If the leash is dropped in certain circumstances, the electronic user device may not send communications to the accessory device, reducing the expenditure of computational and network resources of the electronic user device. The electronic user device may also conserve power (similar to the accessory device) when the leash is dropped.

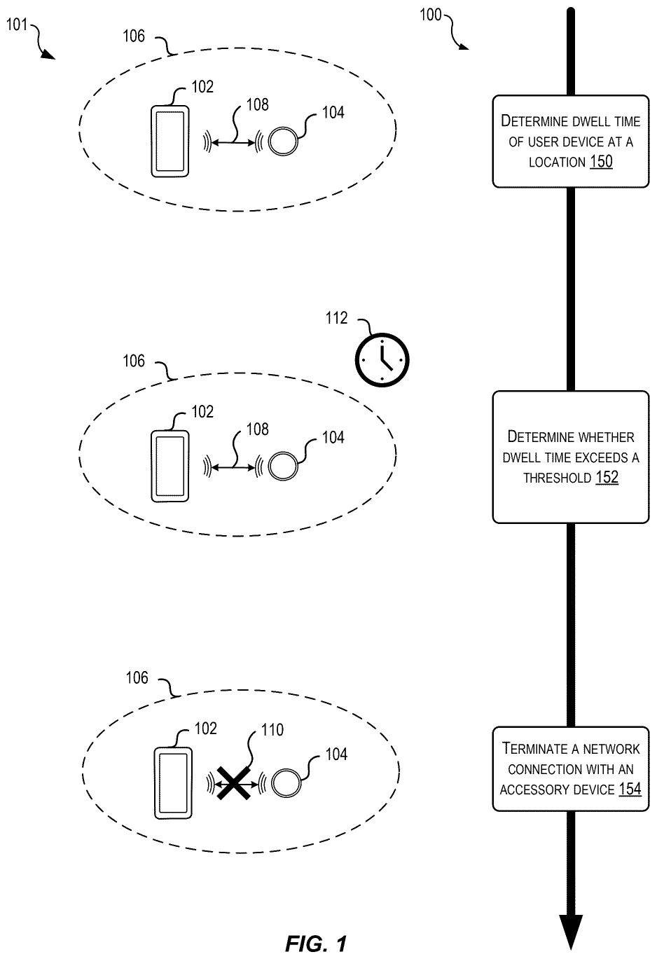

FIG. 1 illustrates a block diagram 101 and a flowchart showing an example process 100 for terminating a network connection 108 between a user device 102 and an accessory device 104, according to some embodiments. The user device 102 can be an example of electronic user devices described herein. The user device 102 can be any suitable device like a smartphone, tablet computer, smartwatch, wearable device, laptop computer, and the like.

The accessory device 104 can be a device such as a finder tag, a smartwatch, earbud headphones equipped with a Bluetooth radio, headphone cases, or similar electronic devices that are configured to communicate with the user device 102 via one or more wireless network communication channels, including, for example, Bluetooth. In particular examples, the accessory device 104 may be a device that is not equipped with a GPS receiver or similar component for determining its location.

The network connection 108 can be a Bluetooth “leash,” a persistent Bluetooth connection between the user device 102 and the accessory device 104. By “persistent,” the network connection 108 is maintained by the user device 102 by communicating with the accessory device 104 at an interval. For example, the user device 102 can communicate via a Bluetooth connection with the accessory device 104 every 1 s. Other intervals are contemplated, including intervals greater than 1 s or less than 1 s (e.g., 900 ms, 2 s, etc.). The network connection 108 (i.e., the leash) may be one of several network connections that can exist between the user device 102 and the accessory device 104. The user device 102 and the accessory device 104 can communicate using a different network connection, which may be a Bluetooth connection. For example, the user device 102 can communicate with the accessory device 104 via Bluetooth to check whether the accessory device 104 is in proximity with the user device 102 (and therefore available for establishing a network connection). This communication can occur at much longer intervals than the leash interval. For example, the user device 102 can communicate with the accessory device every 15 minutes using a Bluetooth connection, so that the average time to a next communication is approximately 7.5 minutes. As another example, the user device 102 can receive Bluetooth broadcast communications (advertisements) from the accessory device 104 at a different interval if the user device 102 is within proximity to the accessory device 104 to receive the broadcast communications. As a further example, the user device 102 can communicate with the accessory device 104 using an ultrawideband radio channel that can be used for precision locating of the accessory device 104. These other communication channels, despite using Bluetooth, can be distinguished from the network connection 108 described herein as the leash.

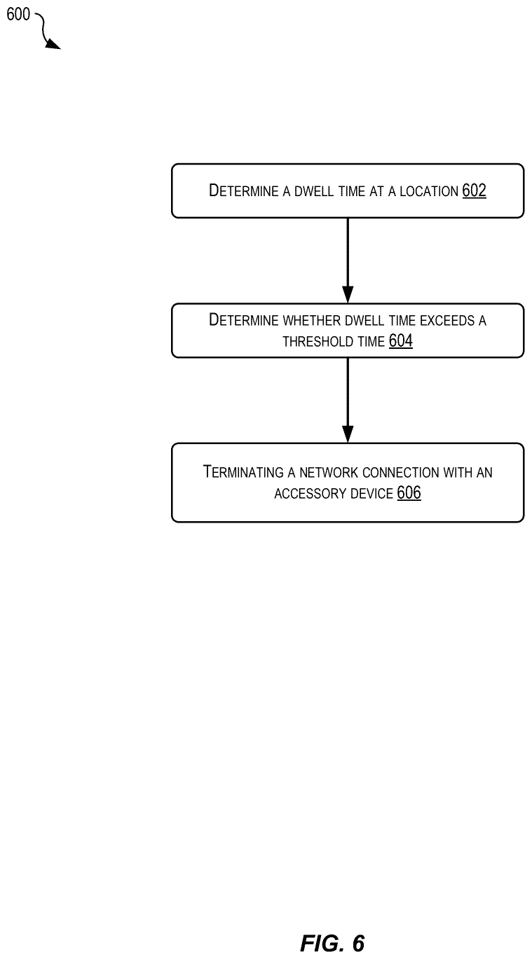

FIGS. 1 and 6 illustrate example flow diagrams showing processes 100 and 600, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100 can begin at block 150 with the user device 102 determining a dwell time of the user device at a location 106. The dwell time can be determined by a locating application that executes on the user device 102. For example, a background process on the user device 102 can be configured to determine the location of the user device 102 using a GPS receiver or similar geolocating component of the user device 102. The locating application can update a data structure or data object with information associated with the coordinates of the user device 102, an accuracy estimate for the coordinates, a timestamp for an arrival at the coordinates, and a timestamp for a departure of the user device 102 from the coordinates. The locating application can update the data structure with location information independently from the operations of process 100. For example, the user device 102 can use the locating application to update location information in the data structure on a fixed interval, in response to detected events at the user device 102 (e.g., receiving advertisements from accessory devices), and/or in response to detecting the user device 102 moving.

The location 106 can represent a localized region in which the user device 102 may be located for a period of time. For example, the location 106 can be the coordinates (e.g., latitude and longitude) associated with a building like a house, an office, a park, a café, or the like. In some embodiments, the location 106 can be predefined. For example, the location 106 can be a known location corresponding to a user's home, a user's workplace, or a location that the user visits frequently, like a café, library, or the like. In some examples, the location 106 can be associated with defined locations from a map application, including businesses, restaurants, or other points of interest. The location 106 can include coordinates within the vicinity of the points of interest. For example, the location 106 can include coordinates within 100 feet of a user's “home,” so that if the user device 102 determines that the user device 102 is within that defined region, the user device 102 is at the location 106 of the user's home. In some embodiments, the location 106 can correspond to locations that are defined by a user or user input. For example, a user can provide the user device 102 with information identifying the user's home, workplace, or other frequented locations as “known locations.” In some embodiments, the user device 102 can determine whether a location is a known location based on repeated visits of the user device 102 to the location.

The dwell time can be a time measured from an arrival time of the user device 102 at the location 106. For example, the user device 102 can update the location information including an arrival time upon detecting that the user device 102 has entered location 106. Then, determining a dwell time of the user device 102 at the location 106 can include determining a time since the arrival time of the user device 102 at the location 106.

As shown in FIG. 1, the user device 102 and the accessory device can have a network connection 108. The network connection 108 (e.g., a leash) can be previously established between the user device 102 and the accessory device 104. For example, the user device 102 can establish the network connection 108 with the accessory device 104 by detecting the accessory device 104 in proximity to the user device 102 prior to arriving at the location 106. As described above, the user device 102 can determine that it is at the location 106. Since the network connection 108 is maintained between the user device 102 and the accessory device 104, the accessory device 104 is also at the location 106 within proximity of the user device 102.

At block 152, the user device 102 can determine whether the dwell time exceeds a threshold time 112. For example, if the user device 102 remains at the location 106 for more than several minutes, the user device 102 can detect that the user device 102 is “dwelling” at the location 106, so that the user device 102 (or the accessory device 104) is less likely to move from the location 106 and leave the accessory device 104. When the network connection 108 is maintained between the user device 102 and the accessory device 104, if the user device 102 departs and leaves the accessory device 104 behind, the breaking of the network connection 108 can trigger the user device 102 to determine the last location of the user device 102 and use that location information as an estimate for the location of the accessory device 104. If the user device 102 is “dwelling” at a location (e.g., for longer than a threshold time 112), then location information for the user device 102 may remain accurate for longer periods of time and allow the user device 102 to terminate the network connection 108 without losing the accuracy of the location information as an estimate for the location of the accessory device 104.

In some embodiments, instead of a threshold time 112, the user device 102 can determine that the location 106 is a location of interest like a known location. For example, the location 106 may be the home of an owner of the user device. If the user device 102 detects that the user device 102 has arrived at the home, then the user device 102 can determine that the user device 102 is at a known location and proceed to terminate the network connection 108 (as described below). In some examples, the location of interest can be a location frequented by the user device 102 (e.g., a workplace, a café, a library, a park). The threshold time 112 may be reduced for locations of interest as compared to unknown locations or locations visited by the user device 102 for the first time. For example, the threshold time 112 may be relatively short (e.g., 1 minute) at the home of the owner of the user device 102, may be slightly longer (e.g., 10 minutes), at a café and may be relatively long (e.g., 30 minutes) at an unknown location like a park visited by the user device 102 for the first time. In various embodiments, the user device 102 can use combinations of threshold time 112 of different lengths and the type of location 106 to determine whether the user device 102 is “dwelling” at the location 106.

At block 154, if the user device 102 determines that the dwell time exceeds the threshold time 112, the user device 102 can terminate 110 the network connection 108 with the accessory device 104. Terminating the network connection 108 can include no longer communicating with the accessory device 104 at an interval. For example, when maintaining a leash, the user device 102 can communicate with the accessory device 104 approximately every 1 s using a Bluetooth connection. If the user device 102 terminates the network connection 108, then the user device 102 can cease the Bluetooth communication with the accessory device at the 1 s intervals.

If the user device 102 terminates 110 the network connection 108 (e.g., drops the Bluetooth leash), the user device 102 can still communicate with the accessory device 104 using a separate communication channel. For example, the user device 102 can be configured to communicate with nearby accessory devices every 15 minutes to determine whether the accessory devices are in proximity to the user device 102. During this longer connection interval check, the user device 102 can determine that the accessory device 104 is no longer in proximity to the user device 102. For example, the user device 102 may have departed from the location 106 with the accessory device 104 left behind at the location. Since the network connection 108 was terminated based on the user device 102 “dwelling” at the location 106, the user device 102 can use the coordinates of the location 106 as an estimate of the location of the accessory device 104 upon detecting that the accessory device 104 was left behind. As described above, a locating application of the user device 102 can update location information including a timestamp for departure of the user device 102 from the location 106.

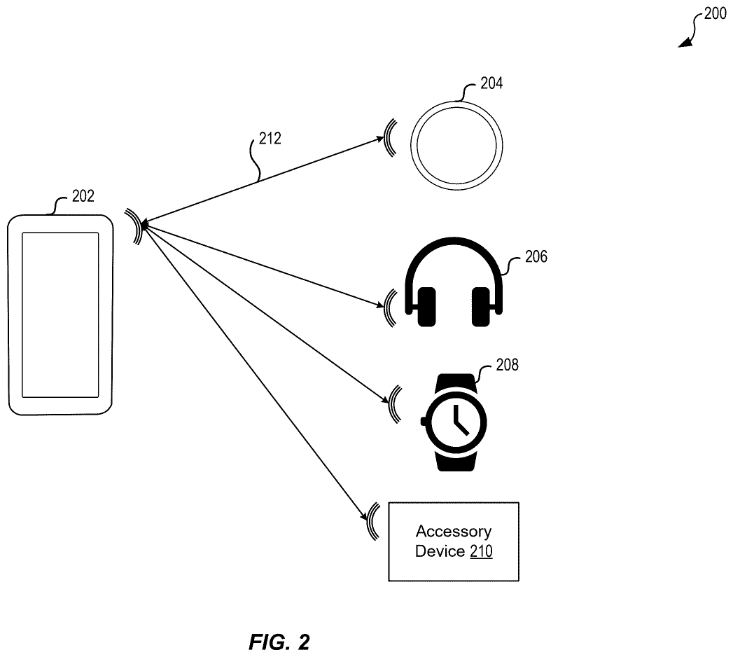

FIG. 2 illustrates a diagram 200 including a user device 202 leashed to various accessory devices 204-210, according to some embodiments. The user device 202 may be an example of user device 102 described above with respect to FIG. 1. Accessory device 204 may be a finder tag, accessory device 206 may be headphones, accessory device 208 may be a smartwatch, and accessory device 210 may be any other accessory device. The accessory devices 204-210 may be examples of accessory device 104 described with respect to FIG. 1.

As depicted in FIG. 2, a user device 202 can maintain a persistent network connection (a leash) with multiple accessory devices 204-210. For example, the user device 202 can have a network connection 212 with accessory device 204 and simultaneously have respective network connections with accessory device 206, accessory device 208, and accessory device 210. The network connection 212 may be an example of network connection 108 of FIG. 1 (e.g., a Bluetooth leash maintained at an interval). In some embodiments, the user device 202 can maintain a maximum of four persistent network connections with four accessory devices. In some other embodiments, the user device 202 can maintain more or fewer persistent network connections with a corresponding number of accessory devices.

The leashes for the accessory devices 204-210 can be maintained independently of one another. For example, the user device 202 can maintain network connection 212 with accessory device 204 at a first interval, and maintain network connections with accessory devices 206-210 at separate intervals. In some examples, the user device 202 can maintain the network connections with accessory devices 204-210 together. For example, the user device 202 can communicate with each leashed accessory device using the corresponding network connection every 1 s.

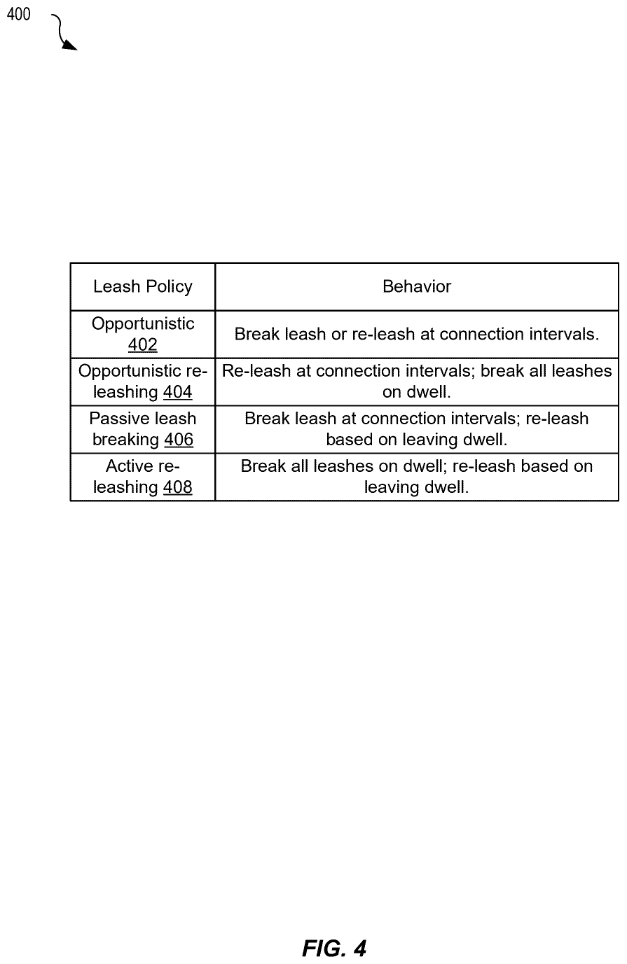

In some embodiments, an accessory device can perform leashing functionality similar to the user device 202. For example, accessory device 208 can be a smartwatch that can maintain leashes with other accessory devices (e.g., accessory device 204, accessory device 206, etc.), including acquiring, dropping, and reacquiring the leashes with the other accessory devices as described herein. In one example, a smartwatch like accessory device 208 can be paired with a smartphone like user device 202. If the smartwatch is paired with the smartphone and the smartphone is not in proximity to the smartwatch, the smartphone can maintain leashes with accessory devices on behalf of the smartphone. In some embodiments, existing leashes between user device 202 and accessory devices like accessory device 204 and accessory device 206 can be “passed” to an accessory device capable of performing the leashing operations described herein. For example, user device 202 can maintain network connections with accessory devices 204-210, including network connection 212. Accessory device 208 can determine that user device 202 is no longer in proximity with accessory device 208. Accessory device 208 can then acquire the network connections with accessory device 204, accessory device 206, and accessory devices 210 to maintain the leashes with those accessory devices. The accessory device 208 can then act similarly to an electronic user device described herein, including operating according to one or more leashing policies described below with respect to FIG. 4. In some embodiments, accessory device 208 can receive an indication from user device 202 that user device 202 has left proximity with the accessory devices 204-210 and that accessory device 208 should acquire the network connections with accessory devices 204, 206, 210. In some embodiments, user device 202 can instruct accessory device 208 to acquire the network connections prior to leaving proximity or prior to accessory device 208 determining that user device 202 is no longer in proximity with accessory device 208.

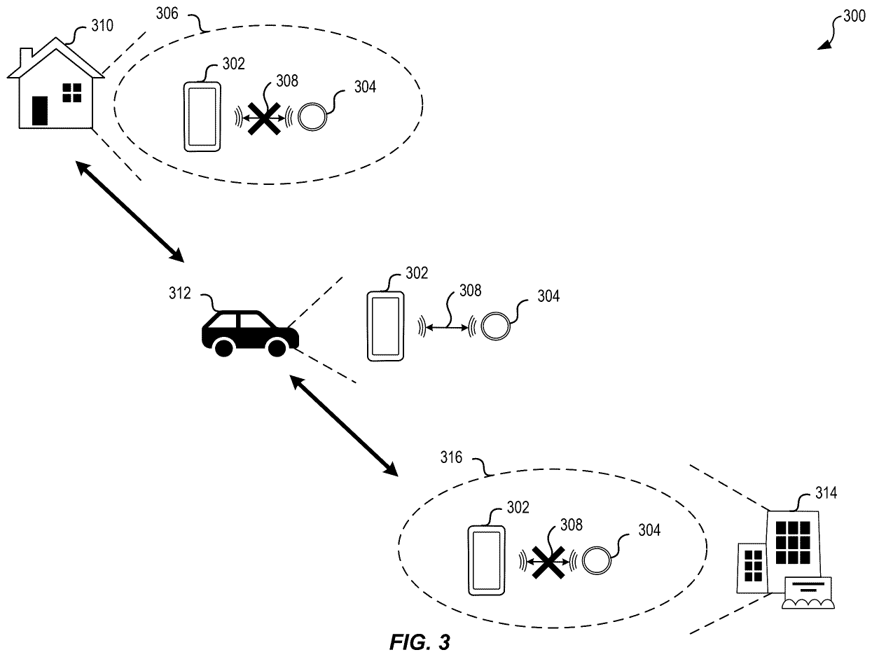

FIG. 3 illustrates a diagram 300 of different leashing states of a user device 302 and an accessory device 304 at different locations 306, 316, according to some embodiments. The user device 302 may be an example of user device 102, accessory device 304 may be an example of accessory device 104, and network connection 308 may be an example of network connection 108 of FIG. 1.

As shown in FIG. 3, the user device 302 can determine that the user device 302 is “dwelling” at a location 306 corresponding to a home 310, for instance a home of an owner of the user device 302. The user device 302 can determine that the user device 302 is dwelling at the location 306 based on a dwell time of the user device 302 at location 306 exceeding a threshold time. Based on the user device 302 determining that the user device is dwelling at location 306, the network connection 308 with the accessory device 304 can be terminated. In this case, because the user device 302 and the accessory device 304 are at the home 310 of the owner of the user device 302, the leash can be dropped to conserve power and networking resources of the user device 302 and the accessory device 304. When the leash is dropped, the user device 302 may communicate with the accessory device 304 less frequently.

If the owner of the user device 302 begins traveling away from home 310 (e.g., location 306), taking along the user device 302 and the accessory device 304, it may be desirable to reestablish the leash to take advantage of the accurate locating capabilities for the accessory device 304 that the leash provides. As shown in the middle portion of FIG. 3, the owner may travel in a vehicle 312 away from home 310, with the user device 302 and accessory device 304 traveling along with the owner in the vehicle 312. The user device 302 can determine that the user device 302 has departed location 306 and is now traveling. The traveling state for the user device 302 can be characterized by not being present at a location or having departed from the previous location (e.g., location 306). Because the user device 302 is now traveling and likely changing its location rapidly, the user device 302 can reestablish the network connection 308 with the accessory device 304. For example, with the network connection 308 terminated while at location 306, the user device 302 can communicate with the accessory device 304 at the next long “check in” connection interval of 7.5 minutes. During this communication, the user device 302 can determine that it has departed from location 306. Based on determining that the user device 302 has departed the location 306, the user device 302 can reestablish the network connection 308 with the accessory device 304 during the long connection interval “check in communication. Additional policies for when to reestablish or terminate leashes with accessory devices is described below with respect to FIG. 4.

As shown in the bottom portion of FIG. 3, the owner of the user device 302 can arrive at an office 314, which can correspond to a workplace of the owner. The user device 302 can determine that the user device 302 is at a location 316 corresponding to the office 314. Based on the user device 302 determining that the user device 302 is now dwelling at the location 316 (e.g., a dwell time at the office 314 exceeding a threshold time), the user device 302 can terminate the network connection 308 that was established during the travel period in the vehicle 312. The ability to drop and reestablish leashes with accessory devices can provide significant power savings for the accessory devices while still allowing the accurate locating functionality of the leash during periods when the user device and the accessory device are most likely to be inadvertently separated.

The location 306 and the location 316 may correspond to known locations for the user device 302. For example, the location 306 can correspond to the home 310 of the owner of the user device 302, which the owner may identify or confirm with input to the user device 302 (e.g., input into a user account associated with the owner and accessible at the user device 302). Similarly, the location 316 can correspond to the office 314 of the owner of the user device 302, which may be identified by the owner with input to the user device 302. In some examples, the locations 306, 316 may not be “known” locations. For example, the locations may correspond to a hotel and a restaurant that the owner visits during a trip. In these examples, the user device 302 can determine that the locations at which the user device 302 may dwell are “unknown” locations such that, even if the user device 302 determines a dwell time exceeding a threshold time, the user device 302 does not terminate the network connection 308. For example, when the owner is on vacation and dwelling at “unknown” locations like the hotel and the restaurant, the locating functionality of the leash is preferable to the power savings of dropping the leash at dwell locations. The user device 302 can then forego dropping the leash even when the dwell time exceeds a threshold time.

FIG. 4 illustrates a table 400 of leashing policies 402-408 that may be implemented by a user device (e.g., user device 102 of FIG. 1), according to some embodiments. The leashing policies 402-408 can provide alternative schemes for when the user device drops and/or reestablishes leashes with accessory devices, based on detected events at the user device when leash drops and leash establishment can occur.

A first leashing policy can be an “opportunistic” policy 402. In the opportunistic policy 402, the user device can both drop leashes and reestablish leashes at a connection interval corresponding to connection attempts with accessory devices. For example, the user device can attempt to communicate with accessory devices in proximity at a relatively long or infrequent interval like 15 minutes. A locating service executing on the user device can update location information for the user device, and the user device can use the location information to determine a dwell time at a location exceeding a threshold time. However, the user device may not drop the leash until the next occurrence of the connection interval at which the user device attempts to connect to accessory devices in proximity. At that interval the user device can determine (based on the location information for the user device) that the user device is dwelling at the location and then drop the leash (e.g., terminate an existing network connection with the accessory device). Similarly, if the user device moves from the location, the user device can update location information indicating a departure from the location. At the next connection interval (when the user device communicates with the accessory device), the user device can reestablish the leash with the accessory device, rather than reestablishing the leash at the time when the user device determines that it has departed a previous location. As described above, the locating service can update location information of the user device on a fixed interval, in response to detected events at the user device, including receiving advertisements from accessory devices, and/or in response to detecting the user device moving.

A second leashing policy can be an opportunistic re-leashing policy 404. In the opportunistic re-leashing policy 404, the user device can reestablish a previously terminated network connection (leash) at the connection interval for connection attempts with the accessory device (e.g., the 15 minute interval described above). The user device will terminate all leashes with accessory devices based on determining that the user device is dwelling at a location. For example, the locating service executing on the user device can update location information for the user device, and the user device can use the location information to determine a dwell time at a location exceeding a threshold time. The user device can terminate the network connection with the accessory device in response to the determination that the user device is dwelling at the location, rather than wait until the next occurrence of the connection interval.

A third leashing policy can be a passive leash breaking policy 406. In the passive leash breaking policy, the user device can terminate leashes with accessory devices at the connection interval for connection attempts with the accessory device (e.g., every 7.5 minutes). However, the user device can reestablish the leash based on determining the user device has departed from a location at which it was dwelling. In the passive leash breaking policy 406, leashes with accessory devices are dropped at the connection interval, but reestablished as soon as the user device detects a departure from a location.

A fourth leashing policy can be an active re-leashing policy 408. In the active re-leashing policy 408, the user device can terminate leashes with accessory devices when the user device determines that the user device is dwelling at a location. Similarly, the user device can reestablish leashes with accessory devices when the user device determines that the user device has departed from the location. In this policy, leashes are terminated and reestablished as soon as the user device determines that the user device is dwelling at a location or has departed a location.

In some embodiments, the operations performed according to the leashing policies 402-408 can apply to more than one accessory device leashed to a user device. When multiple accessory devices and corresponding leashes are maintained by a user device, the order in which leashes are dropped or reacquired may depend on different factors, including user input at the user device associated with one of the multiple accessory devices or by determining which accessory devices are present with the user device from among multiple accessory devices associated with a user account at the user device. For example, in the opportunistic policy 402 or the re-leashing policy 404, when the user device reestablishes leashes for more than one accessory devices at the interval, the user device can first reestablish the leash with the accessory device that most recently received user action. For instance, if during the dwell at the location the user interacts with the user device to play a sound at one accessory device, then when the user device determines to reestablish leashes with multiple accessory devices the user device may first reestablish the leash with the one accessory device that the user chose to play the sound (or any other user-directed interaction with the accessory device). The user device can then reestablish leashes with the other accessory devices. In a similar way, when the user device determines that a leash to multiple accessory devices is to be dropped (e.g., based on dwelling at a location), the user device can drop the leash of an accessory device most recently interacted with by the user device according to user input.

As another example, a user account at the user device may be associated with multiple accessory devices, not all of which may be present with the user device when leashes are dropped/established according to the leaching policies 402-408. As an example, the user may have multiple finder tags associated with their user account. If the user is present at a location with one of those finder tags but not others, and the user device drops a leash with that one finder tag based on dwelling at the location, when the user device attempts to reestablish leashes with accessory devices upon leaving the location, the user device may only establish a leash with the one finder tag rather than all finder tags. In this way, the user device can conserve resources by not attempting to leash/re-leash to accessory devices that are determined to not be present with the user device when the leashes are previously dropped. In the above examples, in some instances the order for dropping or reestablishing leashes with multiple accessory devices may not be deterministic from the leashing policies 402-408. In these cases, the user device can drop or establish leashes in any suitable order determined by the user device.

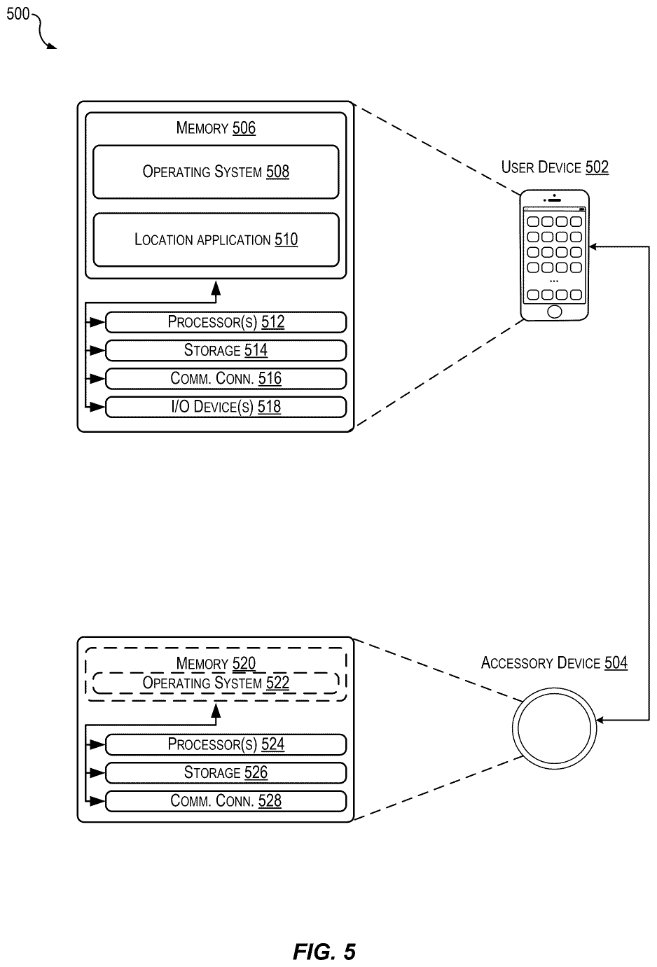

FIG. 5 illustrates an example architecture or environment 500 configured to implement techniques described herein, according to some embodiments. The user device 502 can be an example of the user device 102 of FIG. 1. The accessory device 504 can be an example of the accessory device 104 of FIG. 1. In some examples, the devices may be connected via one or more wireless connections, including Bluetooth, Wi-Fi, and ultrawideband connections.

As noted above, the user device 502 may be configured to determine location information for the user device, determine dwell time at locations, and communicate with one or more accessory devices like accessory device 504 using a wireless communication connection. The user device 502 may be any suitable type of computing device such as, but not limited to, a mobile phone, a smartphone, a personal digital assistant (PDA), a laptop computer, a desktop computer, a thin-client device, a tablet computer, a wearable device, or the like.

In one illustrative configuration, the user device 502 may include at least one memory 506 and one or more processing units (or processor(s)) 512. The processor(s) 512 may be implemented as appropriate in hardware, computer-executable instructions, firmware, or combinations thereof. Computer-executable instruction or firmware implementations of the processor(s) 512 may include computer-executable or machine-executable instructions written in any suitable programming language to perform the various functions described. The user device 502 may also include geo-location devices (e.g., a global navigation satellite system (GNSS) like a global positioning system (GPS) device or the like) for providing and/or recording geographic location information associated with the user device 502.

The memory 506 may store program instructions that are loadable and executable on the processor(s) 512, as well as data generated during the execution of these programs. Depending on the configuration and type of the user device 502, the memory 506 may be volatile (such as random access memory (RAM)) and/or non-volatile (such as read-only memory (ROM), flash memory, etc.). The user device 502 may also include additional removable storage and/or non-removable storage 514 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 506 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 506 and the additional storage 514, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 506 and the additional storage 514 are both examples of non-transitory computer storage media. Additional types of computer storage media that may be present in the user device 502 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 502. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 502 may also contain communications connection(s) 516 that allow the user device 502 to communicate with a data store, another computing device or server, user terminals, and/or other devices via one or more networks, including, for example, a wireless network, a cellular network, and the like. The user device 502 may also include I/O device(s) 518, such as a keyboard, a mouse, a pen, a voice input device, a touch input device, a display. The user device 502 can also include an operating system 508 and/or one or more application programs or services for implementing the features disclosed herein including a location application 510. In some examples, the location application 510 may be configured to implement the features described herein. For example, the location application can include background processes for updating location information of the user device 502, including location coordinates, coordinate accuracy estimation information, arrival and departure timestamps for a location, and the like. The location application 510 can also determine dwell time of the user device 502 at a location, including whether the dwell time exceeds a threshold time. The location application 510 can also be configured to maintain the persistent network connection with the accessory device 504 (and other accessory devices) for the purpose of determining a location of the accessory device 504 if the network connection becomes inoperative due to the accessory device 504 leaving proximity to the user device 502.

The accessory device 504 may also be any suitable type of computing device such as, but not limited to, a mobile phone, a smartphone, a PDA, a laptop computer, a desktop computer, a thin-client device, a tablet computer, a wearable device. In some particular examples, the accessory device 504 may be a computing device that, due to size and power consumption constraints, lacks some of the features of a more general purpose computing device like the user device 502. For example, the accessory device 504 can be a finder tag that includes one or more processing components to implement radio communication including Bluetooth and ultrawideband radio, but may not include a general purpose processor or geolocating components like a GPS. In some examples, the accessory device 504 may be in communication with the user device 502 via the a wireless network connection like a Bluetooth connection.

In some configurations, the accessory device 504 may include at least one memory 520 and one or more processing units (or processor(s)) 524. The processor(s) 524 may be implemented as appropriate in hardware, computer-executable instructions, firmware, or combinations thereof. Computer-executable instruction or firmware implementations of the processor(s) 524 may include computer-executable or machine-executable instructions written in any suitable programming language to perform the various functions described. In some embodiments, the processor(s) 524 may be embodied as systems-on-chips (SoCs), wherein the configuration of the processor(s) 524 is to implement specific functionality for the accessory device 504. For example, the accessory device 504 can include a Bluetooth controller SoC that includes a processor element for implementing the Bluetooth radio for communicating with the user device 502 and/or other computing devices (e.g., for broadcast advertisements for distributed location updating of the accessory device 504).

The memory 520 may store program instructions that are loadable and executable on the processor(s) 524, as well as data generated during the execution of these programs. Depending on the configuration and type of accessory device 504, the memory 520 may be volatile (such as RAM) and/or non-volatile (such as ROM, flash memory, etc.). The accessory device 504 may also include additional removable storage and/or non-removable storage 526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 520 may include multiple different types of memory, such as SRAM, DRAM, or ROM. While the volatile memory described herein may be referred to as RAM, any volatile memory that would not maintain data stored therein once unplugged from a host and/or power would be appropriate. The memory 520 and the additional storage 526, both removable and non-removable, are both additional examples of non-transitory computer-readable storage media. The memory 520 may include an operating system 522 and/or one or more application programs or services for implementing the features disclosed herein.

The accessory device 504 may also contain communications connection(s) 528 that allow the accessory device 504 to communicate with a data store, another computing device or server, user terminals and/or other devices. The accessory device 504 may also include I/O device(s) such as a keyboard, a mouse, a pen, a voice input device, a touch input device, a display, speakers, a printer, etc.

FIG. 6 illustrates a flowchart showing an example process 600 for terminating a network connection, according to some embodiments. The process 600 can be performed by an electronic user device, including user device 502 of FIG. 5 or user device 102 of FIG. 1.

The process 600 can begin at block 602, with the user device determining a dwell time at a location (e.g., location 106 of FIG. 1). For example, the user device can update location information including coordinates for the user device via a GPS receiver. A location application (e.g., location application 510) can update a data structure with the location information and timestamps for arrival at and/or departure from the location. The user device can determine the dwell time based on the time elapsed from an arrival time at the location provided in the data structure. In some embodiments, the user device may have established a network connection (e.g., network connection 108 of FIG. 1) with an accessory device. The accessory device may be within proximity to the user device when the network connection is established and while the network connection is maintained by the user device. In some embodiments, the network connection can include a Bluetooth connection (e.g., Bluetooth Low Energy).

At block 604, the user device can determine whether the dwell time exceeds a threshold time. For example, the user device can determine that the user device has been present at the location for sufficiently long enough to be considered “dwelling” at the location, such that the user device's location is not changing rapidly. As an example, an owner of the user device may have the user device at home along with the accessory device that is connected to the user device via the network connection. The user device may move positions within the home location, but may not travel outside of some range characterizing the location. If the user device is dwelling at a location, the network connection with the accessory device may be terminated to save power and networking resources of the accessory device. Since maintaining the network connection is used to provide accurate information for the last known location of the accessory device in the event that the accessory device becomes separated from the user device (e.g., left behind at a location), when the user device is dwelling at one location for a time period greater than a threshold, the location estimate can be accurately provided even if the network connection (leash) is not maintained. In some embodiments, determining the dwell time is based on a data object or data structure characterizing the location and an arrival time. The arrival time can correspond to the arrival of the user device at the location.

At block 606, the user device can terminate the network connection with the accessory device. The accessory device may be present at the location with the user device. The network connection can be terminated based on a determination that the dwell time exceeds the threshold time. For example, as described above, if the user device and the accessory device are dwelling at the same location, then the network connection (leash) between them can be dropped.

In some embodiments, the network connection can include a persistent wireless network connection characterized by periodic communications between the user device and the accessory device using the persistent wireless connection. The periodic communications can occur at an interval. For example, the user device can transmit data to the accessory device every 1 s while maintaining the network connection, and receive a corresponding response back from the accessory device that confirms the continued operation of the network connection. If the corresponding response is not received from the accessory device, the user device can determine that the network connection has been broken (but not terminated), and indicate that the accessory device is longer in proximity with the user device.

In some embodiments, the user device can determine that the location is an unknown location. For example, the owner of the user device may be traveling so that the location (e.g., a hotel room) at which the user device is dwelling may be a location that has not been visited before. Based on a further determination that the location is the unknown location, the user device can maintaining the network connection rather than terminating the network connection. In doing so, the user device can preserve the accurate locating functionality for the accessory device that is provided by the leash even in situations where the user device and accessory device are dwelling.

In some embodiments, the user device can determine that the location is a location of interest. For example, the location of interest may be a known location based on frequent presence of the user device at the location and/or user input identifying the location as a known location. For instance, the location of interest may be the owner's workplace, to which the owner frequently brings both the user device and the accessory device. The user device can terminate the network connection based on determining that the location is the location of interest. For example, in addition or alternatively to determining that the dwell time exceeds the threshold time, the user device can terminate the network connection upon arriving at the owner's workplace, since that location is known. In some embodiments, the user device can use the determination that the location is a location of interest to adjust the threshold time used to determine that the user device is dwelling at the location. For example, if the location is a café to which the user device is brought frequently, the user device can increase the threshold time for determining that the user device is dwelling at the café to be greater than the threshold time for determining that the user device is dwelling at a workplace, a home, or other known location.

In some embodiments, the user device can determine that the user device has moved from the location and establish (e.g., reestablish) the network connection between the user device and the accessory device. As described above with respect to FIG. 4, establishing or reestablishing the network connection can be based on a leashing policy. In some examples, establishing the network connection occurs in response to the determination that the user device has moved from the location, as in passive leash breaking policy 406 and active re-leashing policy 408. In some examples, the user device can check a proximity of the accessory device on a connection interval, so that establishing the network connection occurs at a next time of the connection interval, as in the opportunistic policy 402 and the opportunistic re-leashing policy 404.

Similarly, the user device can terminate the network connection based on a leashing policy. In some examples, terminating the network connection occurs at a next time of the connection interval, as in the opportunistic policy 402 and passive leash breaking policy 406. In some examples, terminating the network connection occurs in response to the determination that the dwell time exceeds the threshold time, as in the opportunistic re-leashing policy 404 and the active re-leashing policy 408.

In some embodiments, the accessory device broadcasts an advertisement request to the user device, the broadcast occurring at an advertisement interval, and the broadcast using a connection different from the network connection.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

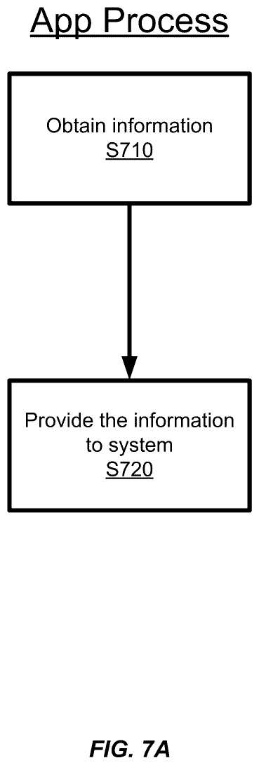

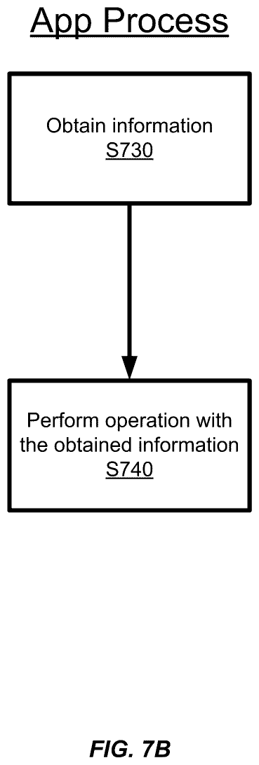

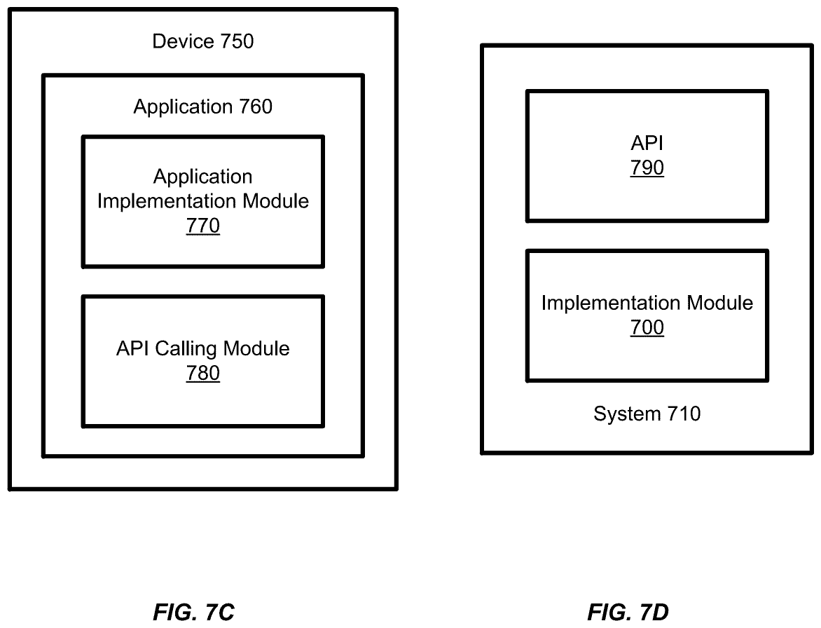

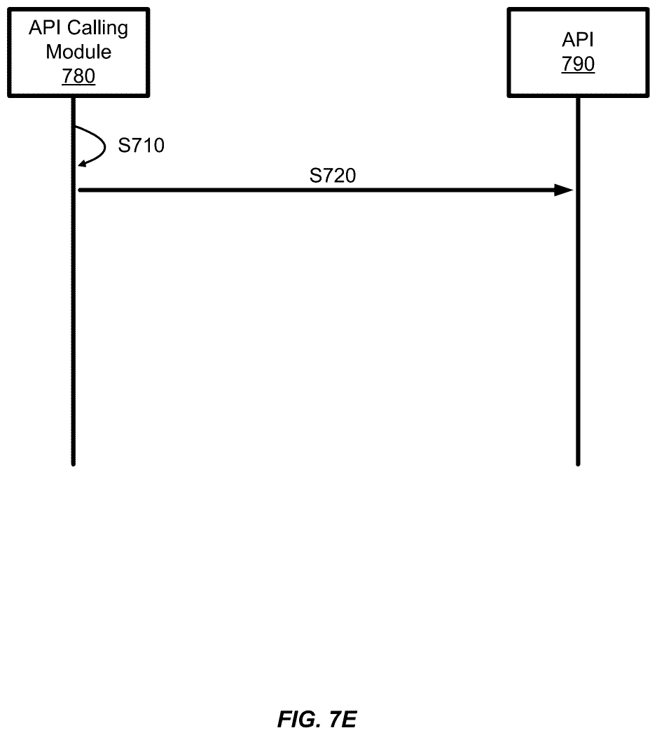

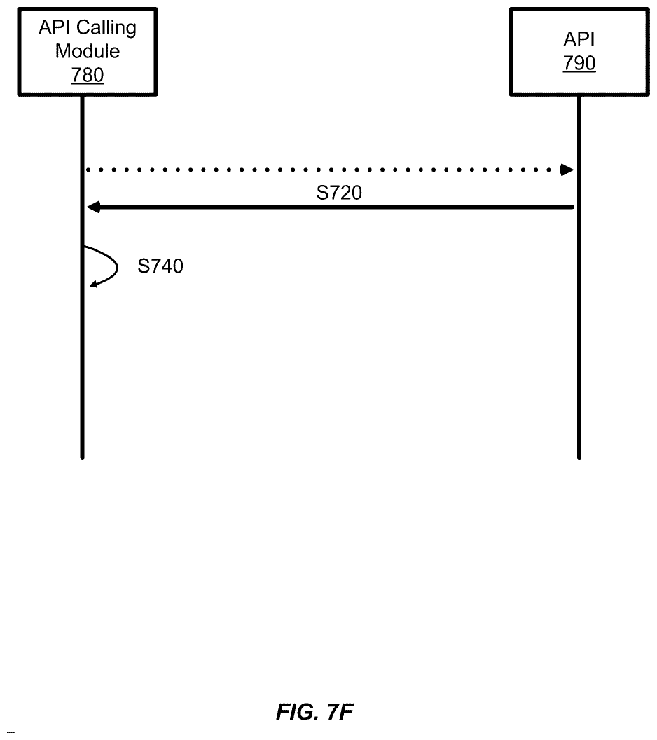

Implementations within the scope of the present disclosure include a computer-readable storage medium that encodes instructions organized as an application (e.g., application 760) that, when executed by one or more processing units, control an electronic device (e.g., device 750) to perform the method of FIG. 7A, the method of FIG. 7B, and/or one or more other processes and/or methods described herein.

It should be recognized that application 760 (shown in FIG. 7C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 760 is an application that is pre-installed on device 750 at purchase (e.g., a first party application). In other embodiments, application 760 is an application that is provided to device 750 via an operating system update file (e.g., a first party application or a second party application). In other embodiments, application 760 is an application that is provided via an application store. In some embodiments, the application store can be an application store that is pre-installed on device 750 at purchase (e.g., a first party application store). In other embodiments, the application store is a third-party application store (e.g., an application store that is provided by another application store, downloaded via a network, and/or read from a storage device).

Referring to FIG. 7A and FIG. 7E, application 760 obtains information (e.g., S710). In some embodiments, at S710, information is obtained from at least one hardware component of the device 750. In some embodiments, at S710, information is obtained from at least one software module of the device 750. In some embodiments, at S710, information is obtained from at least one hardware component external to the device 750 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 760 provides the information to a system (e.g., S720).

In some embodiments, the system (e.g., 710 shown in FIG. 7D) is an operating system hosted on the device 750. In some embodiments, the system (e.g., 710 shown in FIG. 7D) is an external device (e.g., a server, a peripheral device, an accessory, a personal computing device, etc.) that includes an operating system.

Referring to FIG. 7B and FIG. 7F, application 760 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 760 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 710 based on the information.

In some embodiments, one or more steps of the method of FIG. 7A and/or the method of FIG. 7B is performed in response to a trigger. In some embodiments, the trigger includes detection of an event, a notification received from system 710, a user input, and/or a response to a call to an API provided by system 710.

In some embodiments, the instructions of application 760, when executed, control device 750 to perform the method of FIG. 7A and/or the method of FIG. 7B by calling an application programming interface (API) (e.g., API 790) provided by system 710. In some embodiments, application 760 performs at least a portion of the method of FIG. 7A and/or the method of FIG. 7B without calling API 790.

In some embodiments, one or more steps of the method of FIG. 7A and/or the method of FIG. 7B includes calling an API (e.g., API 790) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 7C, device 750 is illustrated. In some embodiments, device 750 is a personal computing device, a smart phone, a smart watch, a fitness tracker, a head mounted display (HMD) device, a media device, a communal device, a speaker, a television, and/or a tablet. As illustrated in FIG. 7C, device 750 includes application 760 and operating system (e.g., system 710 shown in FIG. 7D). Application 760 includes application implementation module 770 and API calling module 780. System 710 includes API 790 and implementation module 700. It should be recognized that device 750, application 760, and/or system 710 can include more, fewer, and/or different components than illustrated in FIGS. 7C and 7D.

In some embodiments, application implementation module 770 includes a set of one or more instructions corresponding to one or more operations performed by application 760. For example, when application 760 is a messaging application, application implementation module 770 can include operations to receive and send messages. In some embodiments, application implementation module 770 communicates with API calling module to communicate with system 710 via API 790 (shown in FIG. 7D).

In some embodiments, API 790 is a software module (e.g., a collection of computer-readable instructions) that provides an interface that allows a different module (e.g., API calling module 780) to access and/or use one or more functions, methods, procedures, data structures, classes, and/or other services provided by implementation module 700 of system 710. For example, API-calling module 780 can access a feature of implementation module 700 through one or more API calls or invocations (e.g., embodied by a function or a method call) exposed by API 790 and can pass data and/or control information using one or more parameters via the API calls or invocations. In some embodiments, API 790 allows application 760 to use a service provided by a Software Development Kit (SDK) library. In other embodiments, application 760 incorporates a call to a function or method provided by the SDK library and provided by API 790 or uses data types or objects defined in the SDK library and provided by API 790. In some embodiments, API-calling module 780 makes an API call via API 790 to access and use a feature of implementation module 700 that is specified by API 790. In such embodiments, implementation module 700 can return a value via API 790 to API-calling module 780 in response to the API call. The value can report to application 760 the capabilities or state of a hardware component of device 750, including those related to aspects such as input capabilities and state, output capabilities and state, processing capability, power state, storage capacity and state, and/or communications capability. In some embodiments, API 790 is implemented in part by firmware, microcode, or other low level logic that executes in part on the hardware component.

In some embodiments, API 790 allows a developer of API-calling module 780 (which can be a third-party developer) to leverage a feature provided by implementation module 700. In such embodiments, there can be one or more API-calling modules (e.g., including API-calling module 780) that communicate with implementation module 700. In some embodiments, API 790 allows multiple API-calling modules written in different programming languages to communicate with implementation module 700 (e.g., API 790 can include features for translating calls and returns between implementation module 700 and API-calling module 780) while API 790 is implemented in terms of a specific programming language. In some embodiments, API-calling module 780 calls APIs from different providers such as a set of APIs from an OS provider, another set of APIs from a plug-in provider, and/or another set of APIs from another provider (e.g., the provider of a software library) or creator of another set of APIs.

Examples of API 790 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 700 is a system (e.g., operating system, server system) software module (e.g., a collection of computer-readable instructions) that is constructed to perform an operation in response to receiving an API call via API 790. In some embodiments, implementation module 700 is constructed to provide an API response (via API 790) as a result of processing an API call. By way of example, implementation module 700 and API-calling module 780 can each be any one of an operating system, a library, a device driver, an API, an application program, or other module. It should be understood that implementation module 700 and API-calling module 780 can be the same or different type of module from each other. In some embodiments, implementation module 700 is embodied at least in part in firmware, microcode, or other hardware logic.

In some embodiments, implementation module 700 returns a value through API 790 in response to an API call from API-calling module 780. While API 790 defines the syntax and result of an API call (e.g., how to invoke the API call and what the API call does), API 790 might not reveal how implementation module 700 accomplishes the function specified by the API call. Various API calls are transferred via the one or more application programming interfaces between API-calling module 780 and implementation module 700. Transferring the API calls can include issuing, initiating, invoking, calling, receiving, returning, and/or responding to the function calls or messages. In other words, transferring can describe actions by either of API-calling module 780 or implementation module 700. In some embodiments, a function call or other invocation of API 790 sends and/or receives one or more parameters through a parameter list or other structure.

In some embodiments, implementation module 700 provides more than one API, each providing a different view of or with different aspects of functionality implemented by implementation module 700. For example, one API of implementation module 700 can provide a first set of functions and can be exposed to third party developers, and another API of implementation module 700 can be hidden (e.g., not exposed) and provide a subset of the first set of functions and also provide another set of functions, such as testing or debugging functions which are not in the first set of functions. In some embodiments, implementation module 700 calls one or more other components via an underlying API and thus be both an API calling module and an implementation module. It should be recognized that implementation module 700 can include additional functions, methods, classes, data structures, and/or other features that are not specified through API 790 and are not available to API calling module 780. It should also be recognized that API calling module 780 can be on the same system as implementation module 700 or can be located remotely and access implementation module 700 using API 790 over a network. In some embodiments, implementation module 700, API 790, and/or API-calling module 780 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 800 of FIG. 8, process 900 of FIG. 9, process 1000 of FIG. 10, process 1100 of FIG. 11, and/or process 1200 of FIG. 12 are performed at a first computer system (as described herein) via a system process (e.g., an operating system process, a server system process) that is different from one or more applications executing and/or installed on the first computer system.

In some embodiments, process 800 of FIG. 8, process 900 of FIG. 9, process 1000 of FIG. 10, process 1100 of FIG. 11, and/or process 1200 of FIG. 12 are performed at a first computer system (as described herein) by an application that is different from a system process. In some embodiments, the instructions of the application, when executed, control the first computer system to perform process 800 of FIG. 8, process 900 of FIG. 9, process 1000 of FIG. 10, process 1100 of FIG. 11, and/or process 1200 of FIG. 12 by calling an application programming interface (API) provided by the system process. In some embodiments, the application performs at least a portion of process 800 of FIG. 8, process 900 of FIG. 9, process 1000 of FIG. 10, process 1100 of FIG. 11, and/or process 1200 of FIG. 12 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 800 of FIG. 8, process 900 of FIG. 9, process 1000 of FIG. 10, process 1100 of FIG. 11, and/or process 1200 of FIG. 12 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 790 defines a first API call that can be provided by API calling module 790. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 750) that runs the application. In some embodiments, the implementation module is included in an electronic device that is separate from the device that runs the application.

Illustrative methods and systems for managing persistent network connections between user devices and accessory devices are described above. Some or all of these systems and methods may, but need not, be implemented at least partially by architectures such as those shown at least in FIGS. 1-6. While many of the examples are described above with reference to personal, activity, and/or health-related information, it should be understood that any type of user information or non-user information (e.g., data of any type) may be managed using these techniques. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle®, Microsoft®, SAP®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is determining location information of user devices, which may include storing some aspect of the data on a server. The present disclosure contemplates that in some instances, this gathered data may include personally identifiable information (PII) data that uniquely identifies or can be used to locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the location information can be used to determine whether a user is dwelling at particular locations and whether these locations are locations of interest for the user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method comprising:
determining, by a user device, a dwell time at a location;
determining, by the user device, whether the dwell time exceeds a threshold time; and
based on a determination that the dwell time exceeds the threshold time, terminating, by the user device, a network connection with an accessory device, the accessory device present at the location with the user device, the network connection comprising a persistent wireless network connection characterized by periodic communications between the user device and the accessory device, and the network connection previously established by the user device based on a proximity of the accessory device to the user device.

2. The method of claim 1, wherein the network connection comprises a Bluetooth connection.

3. The method of claim 1, further comprising:
determining, by the user device, that the location is an unknown location; and
based on a further determination that the location is the unknown location, maintaining the network connection.

4. The method of claim 1, further comprising:
determining, by the user device, that the location is a location of interest,
wherein terminating the network connection comprises terminating the network connection based on a further determination that the location is the location of interest.

5. The method of claim 1, further comprising:
determining, by the user device, that the user device has moved from the location; and
based on a further determination that the user device has moved from the location, reestablishing the network connection between the user device and the accessory device.

6. The method of claim 5, wherein reestablishing the network connection occurs in response to the further determination that the user device has moved from the location.

7. The method of claim 5, wherein the user device checks a proximity of the accessory device on a connection interval, and wherein reestablishing the network connection occurs at a next time of the connection interval.

8. The method of claim 1, wherein the user device checks a proximity of the accessory device on a connection interval, and wherein terminating the network connection occurs at a next time of the connection interval.

9. The method of claim 1, wherein terminating the network connection occurs in response to the determination that the dwell time exceeds the threshold time.

10. The method of claim 1, wherein the network connection is maintained by a communication between the user device and the accessory device at an interval.

11. The method of claim 1, wherein the accessory device broadcasts an advertisement request to the user device, the broadcast occurring at an advertisement interval, and the broadcast using a connection different from the network connection.

12. The method of claim 1, wherein determining the dwell time is based on a data object characterizing the location and an arrival time, the arrival time corresponding to the arrival of the user device at the location.

13. A user device, comprising:
one or more processors; and
one or more memories storing computer-executable instructions that, when executed by the one or more processors, cause the user device to perform operations comprising:
determining, by a user device, a dwell time at a location;
determining, by the user device, whether the dwell time exceeds a threshold time; and
based on a determination that the dwell time exceeds the threshold time, terminating, by the user device, a network connection with an accessory device, the accessory device present at the location with the user device, the network connection comprising a persistent wireless network connection characterized by periodic communications between the user device and the accessory device, and the network connection previously established by the user device based on a proximity of the accessory device to the user device.

14. The user device of claim 13, further comprising:
determining, by the user device, that the location is an unknown location; and
based on a further determination that the location is the unknown location, maintaining the network connection.

15. The user device of claim 13, further comprising:
determining, by the user device, that the location is a location of interest,
wherein terminating the network connection comprises terminating the network connection based on a further determination that the location is the location of interest.

16. The user device of claim 13, wherein the user device checks a proximity of the accessory device on a connection interval, and wherein terminating the network connection occurs at a next time of the connection interval.

17. A non-transitory computer-readable medium storing computer-executable instructions that, when executed by one or more processors, cause a first accessory device to perform operations comprising:
maintaining, by the first accessory device, a first network connection with a user device, the user device maintaining a second network connection with a second accessory device;
determining, by the first accessory device, whether the user device is in proximity to the first accessory device; and
based on a determination that the user device is not in proximity to the first accessory device, establishing, by the first accessory device, a third network connection with the second accessory device, the second accessory device present at a location with the first accessory device.

18. The non-transitory computer-readable medium of claim 17, wherein the first accessory device is a smartwatch, and wherein the user device is a smartphone.

19. The non-transitory computer-readable medium of claim 17, wherein the first network connection, the second network connection, and the third network connection each comprise a persistent Bluetooth connection.

20. The non-transitory computer-readable medium of claim 17, wherein determining whether the user device is in proximity to the first accessory device comprises receiving an indication from the user device that the user device has departed from the location.
